(19) United States
(12) Patent Application Publication
(10) Pub. No.: US 2025/0044812 A1
(43) Pub. Date: Feb. 6, 2025

(54) SYSTEMS AND METHODS FOR HELIOSTAT MIRROR TRACKING

(71) Applicant: Idealab Studio, LLC, Pasadena, CA (US)

(72) Inventors: William Tod Gross, Pasadena, CA (US); Andrea Pedretti, Thousand Oaks, CA (US)

(21) Appl. No.: 18/768,412

(22) Filed: Jul. 10, 2024

Related U.S. Application Data
(60) Provisional application No. 63/517,283, filed on Aug. 2, 2023.

(51) Int. Cl. G05D 3/10; F24S 23/77; F24S 30/452; F24S 50/20

(52) U.S. Cl. CPC G05D 3/105; F24S 23/77; F24S 30/452; F24S 50/20; F24S 2050/25

(57) ABSTRACT

An aspect of the present disclosure relates to methods and systems for enhancing the flux distribution on a heliostat receiver target. A plurality of mirrors in a heliostat array are caused to vibrate at respective different frequencies. One or more images are captured of the total flux on a heliostat receiver target. Fast Fourier Transforms are performed in real time with respect to the one or more images of the total flux on the heliostat receiver target to obtain frequency domain information. A real time determination is made of the flux contribution by a given individual mirror using the frequency domain information. A desired total flux distribution is determined. One or more of the plurality of mirrors in the heliostat array are caused to be oriented to obtain the desired total flux.

### BACKGROUND OF THE INVENTION

### Incorporation by Reference to any Priority Applications

Any and all applications for which a foreign or domestic priority claim is identified in the Application Data Sheet as filed with the present application are hereby incorporated by reference under 37 CFR 1.57.

### COPYRIGHT NOTICE

A portion of the disclosure of this patent document contains material which is subject to copyright protection. The copyright owner has no objection to the facsimile reproduction by anyone of the patent document and/or the patent disclosure as it appears in the United States Patent and Trademark Office patent file and/or records, but otherwise reserves all copyrights whatsoever.

### BACKGROUND

### Field of the Invention

The present disclosure relates to methods and systems for heliostat mirror tracking, and in particular, for controlling an array of heliostat mirrors so that they are appropriately oriented.

### Description of the Related Art

Efforts are being made to reduce fossil fuel consumption and the associated pollution, so as to reduce the severity of climate change. A highly desirable alternative to fossil fuel is solar thermal power generation. For example, heliostat systems are increasingly used to provide thermal power generation of electricity. A heliostat system may include a solar power tower (SPT), comprising a central receiver system and large numbers of independently actuated mirrors reflecting the concentrated solar radiation toward the effective area of the receiver system.

Advantageously, heliostats provide high conversion efficiency, high working temperatures, and large thermal storage capability.

However, heliostat arrays present technical challenges. Directing the reflected sunlight from the various heliostat mirrors onto the same desired region of focus on the central receiver as the sun changes position throughout the day and throughout the year can be challenging. The failure to create the appropriate flux can reduce the efficiency of the heliostat and may result in overheating of certain components of the receiver system.

Thus, as the time of day varies and as the time of year varies, the angle of the sun in the sky varies, and thus the heliostat mirrors must be continually repositioned to keep directing a maximum amount of reflected sunlight onto the active area of the central receiver. Further, wind and other environmental conditions may perturb the orientations of mirrors. Still further, even if the heliostat mirrors are controlled by calibrated actuators, the calibration of the actuators may drift with time, causing pointing inaccuracies. Given that the heliostat mirrors may be located some distance away from the central receiver, even minor errors in mirror orientation can cause the reflected sunlight to miss the receiver or otherwise have an undesirable flux pattern, thereby causing the heliostat array as a whole to function with suboptimal efficiency.

Conventional attempts to solve the foregoing challenge have not provided adequate mirror orientation correction, and/or have required large numbers of expensive, failure prone supporting devices.

Thus, improved systems and methods are needed to overcome the foregoing challenges and to provide enhanced positioning of heliostat mirrors.

### BRIEF DESCRIPTION OF THE DRAWINGS

While each of the drawing figures illustrates a particular aspect for purposes of illustrating a clear example, other embodiments may omit, add to, reorder, and/or modify any of the elements shown in the drawing figures. For purposes of illustrating clear examples, one or more figures may be described with reference to one or more other figures, but using the particular arrangement illustrated in the one or more other figures is not required in other embodiments.

FIG. 1A illustrates an example heliostat array comprising aspects of the present disclosure.

FIG. 1B illustrates an example heliostat mirror configured with a perturbation mechanism.

FIG. 2 illustrates and example control system architecture.

FIG. 3 illustrates an example process.

FIGS. 4A-4G illustrate aspects of using an FFT process to determine the flux from respective mirrors.

### DETAILED DESCRIPTION

Systems and methods are described that are configured to provide enhanced positioning of heliostat mirrors so as to achieve a desired flux pattern on a central receiver to thereby provide enhanced heliostat performance.

As similarly described elsewhere herein, heliostat arrays may contain large numbers (e.g., thousands of flat or slightly concave mirrors), and maintaining alignment of these mirrors over time towards the central receiver to achieve the desired flux pattern is very challenging. Flux is the amount of solar energy or sunlight that is incident on a particular surface or target. In particular, flux is a measure of the power or energy per unit area received from the sun.

The mirror orientation (and hence the reflected light pointing angle) of a given mirror may be controlled via an actuator, such as a motor (e.g., a stepper motor), or hydraulic system. The actuator may be commanded by a heliostat control system that provides azimuth and elevation control commands. Azimuth control refers to the rotation of the mirror around a vertical axis, while elevation control refers to the tilt or rotation of the mirror around a horizontal axis. The heliostat control system thus controls the mirrors to track the movement of the sun throughout the day.

The central receiver may be mounted on a tower. The central receiver may be made of ceramic and/or metal alloys configured to withstand the temperatures in the receiver. The receiver may be volumetric receiver or tubular receiver (e.g., comprising parallel and/or spiral tubes). A heat transfer fluid absorbs heat in the receiver and then transfers it to a power generation system via an intermediate heat exchanger. Optionally, molten salts may be utilized as they can serve also as a heat storage medium. Optionally, a direct steam generator may be utilized with the heliostat.

Once heated, the heated medium travels through the heat exchanger, where the heat is used to create steam. The steam in turn may be used to operate a steam turbine and create electrical energy. Other techniques may be utilized to convert the heat into electricity and/or the heat may be utilized for other tasks.

Using a larger number of heliostat mirrors in an array, all focused onto the same central receiver, typically improves efficiency because more solar energy can be collected and used by the same receiver. As a result, although heliostat arrays can be created using as little as one heliostat mirror and one receiver, it is advantageous for heliostat arrays to contain many thousands of individual heliostat mirrors (e.g., arrayed over one or more acres of land).

As similarly discussed elsewhere herein, the reflected sunlight from the various heliostat mirrors may be directed onto the same desired region of focus on the central receiver (which may be a calibrated target) as the sun changes position throughout the day, and throughout the year can be challenging. The failure to create the appropriate flux can reduce the efficiency of the heliostat and may result in overheating of certain components of the receiver system.

As the time of day varies and as the time of year varies, the angle of the sun in the sky varies, and thus the heliostat mirrors need to be continually repositioned to keep directing a maximum amount of reflected sunlight onto the active area of the central receiver. Further, wind and other environmental conditions may perturb the orientations of mirrors. Still further, even if the heliostat mirrors are controlled by calibrated actuators, the calibration of the actuators may drift with time, causing pointing inaccuracies. Given that the heliostat mirrors may be located some distance away from the central receiver, even minor errors in mirror orientation can cause the reflected sunlight to miss the receiver or otherwise have an undesirable flux pattern, thereby causing the heliostat array as a whole to function with suboptimal efficiency.

Conventional attempts to solve the foregoing challenges have not provided adequate mirror orientation correction, and/or have required large numbers of expensive, failure prone supporting devices. For example, certain attempts have required that each mirror include a photosensor and/or a light emitter to generate a secondary beam. In addition, a target screen, positioned above the receiver, as well as numerous cameras positioned around the target screen, have been utilized in attempts to overcome the foregoing challenges.

Systems and methods are described that provide enhanced mirror orientation positioning optionally with fewer and/or more reliable components than such conventional systems.

As will be described, optionally each mirror may be vibrated at a respective different frequency (e.g., 100 hz, 200zh, 300 hz, etc.). A high resolution camera (e.g., a black and white camera with 14 or 16 bit depth or other adequate depth, such as where the bit depth enables more shades of grey to be displayed than there are mirrors in the heliostat array) may be utilized to capture images of the total receiver flux corresponding to the light focused on a receiver target.

A Fast Fourier Transform (FFT) may be applied to convert the images from the time domain to the frequency domain in real time. The different frequency peaks correspond to the light reflected from respective mirrors vibrating at different frequencies. A computed image may be generated, based at least in part on the output of the FFT, showing the position of the center of the beam from a given mirror (e.g., in black) on the receiver target as well as a halo (e.g., a light colored halo) about the center of the beam corresponding to the mirror vibration. The center and the halo may be at a rotated angle corresponding to the flux orientation from the mirror.

Once the flux/beam position on the receiver target for each mirror is so determined, the heliostat control system may determine how to orient the mirrors so as to achieve the desired receiver flux. For example, it may be desirable to focus the beams from each mirror onto the exact same spot on the receiver target to provide a very tight flux pattern. Alternatively, it may be desirable to spread the beams to fully cover the receiver target with the flux pattern, and so certain mirrors may be oriented to provide a beam at the center of the target, while other mirrors may be oriented to focus beams at respective corners of the target. By way of further example, if the receiving comprises a coil, it may be desirable to focus additional flux towards the coil input which may be cooler than other portions of the coil, and so a selected number of mirrors may be oriented to focus additional light beams on the coil input. By way of yet further example, if the receiver comprises parallel pipes, it may be desired to reduce the flux on the hotter pipes to reduce hotspots, and so certain mirrors may be oriented to ensure that they do not focus beams on such hotspots.

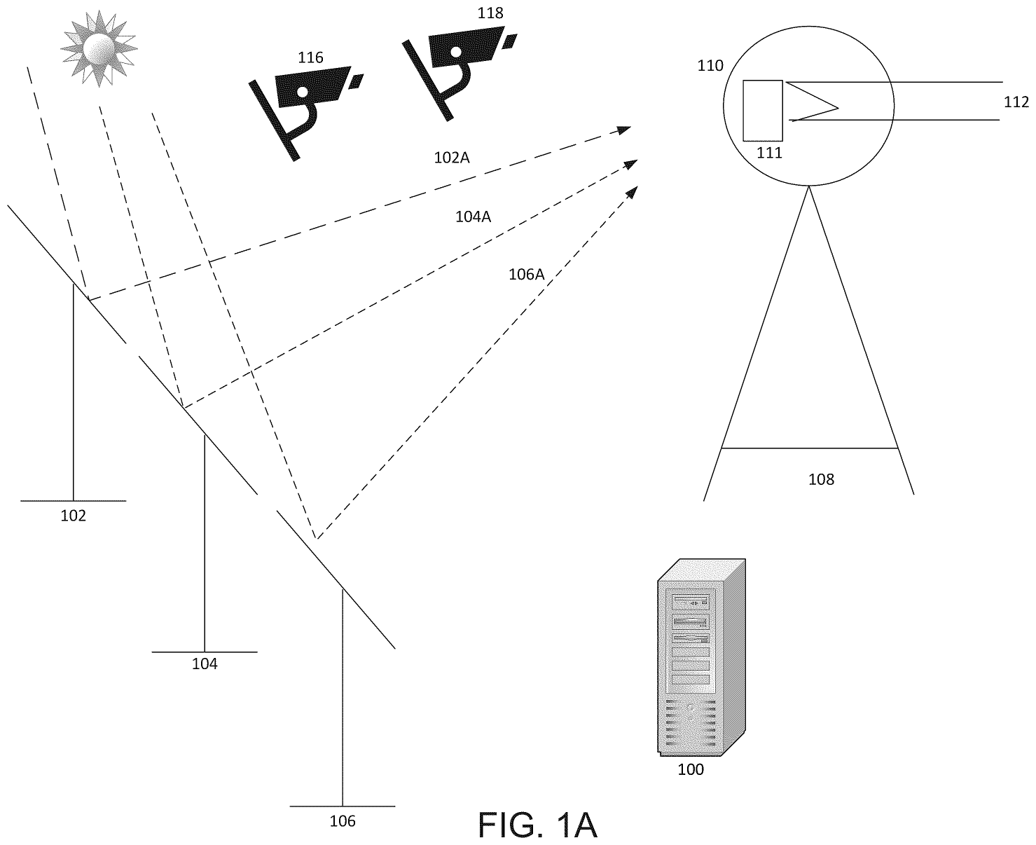

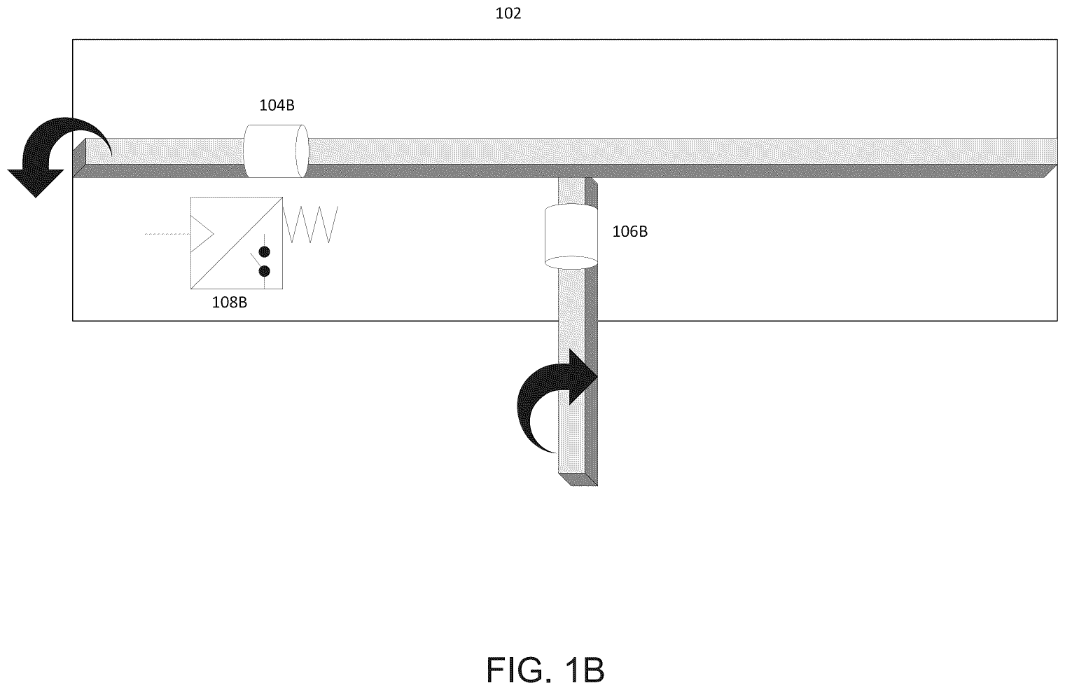

FIG. 1A illustrates an example heliostat array comprising aspects of the present disclosure. The example heliostat array comprises mirrors 102, 104, 106 (although there may be hundreds, thousands, or tens of thousands of mirrors). A heliostat control system 100 is configured to command (e.g., via azimuth and elevation control commands) mirror actuators to control the azimuth and elevation of the mirrors to track the movement of the sun throughout the day and to provide the desired total flux on the calibration receiver target 111 via reflected solar light 102A, 104A, 106A. The calibration receiver target 111 is positioned on a solar receiver 110, which is mounted to a tower 108. Heat transfer fluid may be routed through the receiver 110 via a conduit 112 which may comprise a spiral tube or a set of parallel tubes.

As described elsewhere herein, each mirror may comprise a perturbation mechanism configured to cause the mirror to vibrate at specific commanded frequency (e.g., at a frequency commanded by the heliostat control system 100). Each mirror (or set of mirrors) may be commanded and/or configured to vibrate at different frequencies to enable contribution of the flux generated by the corresponding mirror (or set of mirrors) in the total flux to be distinguished via the FFT process. The perturbation mechanism may be in the form of an ultrasonic transducer, a piezoelectric actuator, and electromagnetic shaker, an eccentric rotating mass (ERM) actuator, a voice coil actuator, a hydraulic or pneumatic actuator, and/or the like, mounted to the mirror and/or the panel's positioning azimuth and/or elevation actuators. Optionally, in addition or instead, the heliostat control system 100 may command the actuators to quickly tilt or otherwise move the mirror back and forth so as to cause the mirror to vibrate without the use of a separate perturbation mechanism.

A camera 116 (e.g., a high resolution, 14 bit or greater black and white camera) is positioned to observe and capture images of the receiver calibration target 111 and the flux pattern thereon resulting from the reflected solar light 102A, 104A, 106A. The captured images of the total flux generated by the array of mirrors vibrating at different frequencies may be utilized to determine, in real time, the flux pattern contributed by individual mirrors using a Fast Fourier Transform (FFT) process as described elsewhere herein. An infrared camera 118 may be positioned to observe and capture images of the receiver calibration target 111 to detect hot and cold spots or underfilled areas. The detection of hot and cold spots may be utilized by the heliostat control system 100, in real time, to adjust the flux patterns accordingly to reduce the hot and/or cold spots and to fill the areas of the receiver target 111 that were underfilled.

Thus, the heliostat control system 100 may control the azimuth and elevation actuators of each mirror separately to orient the mirrors to produce a desired total flux.

FIG. 1B illustrates a rear side of example mirror 102. The mirror 102 may include multiple layers, including glass, silver (or other reflective material such as aluminum), copper, a UV filter, and a backing. Actuators 104B, 106B are configured to rotate the mirror 102 around the horizontal access and the vertical access respectively. A perturbation mechanism 108B is configured to cause the mirror to vibrate at a specified commanded frequency. As similarly discussed elsewhere herein, the perturbation mechanism 108B may be in the form of an ultrasonic transducer, a piezoelectric actuator, and electromagnetic shaker, an eccentric rotating mass (ERM) actuator, a voice coil actuator, an hydraulic or pneumatic actuator, and/or the like, mounted to rear or other portion of the mirror 102 and/or on the mirror's positioning actuators 104B, 106B.

Thus, optionally, no extra target screens are required (although such may be used), no detector is required at the perimeter of the receiver (although such may be used), and only a single camera may be needed to view the actual receiver target (although additional cameras may be used). The disclosed architecture enables the receiver to be painted with any desired flux pattern via the individual control of the heliostat array mirrors.

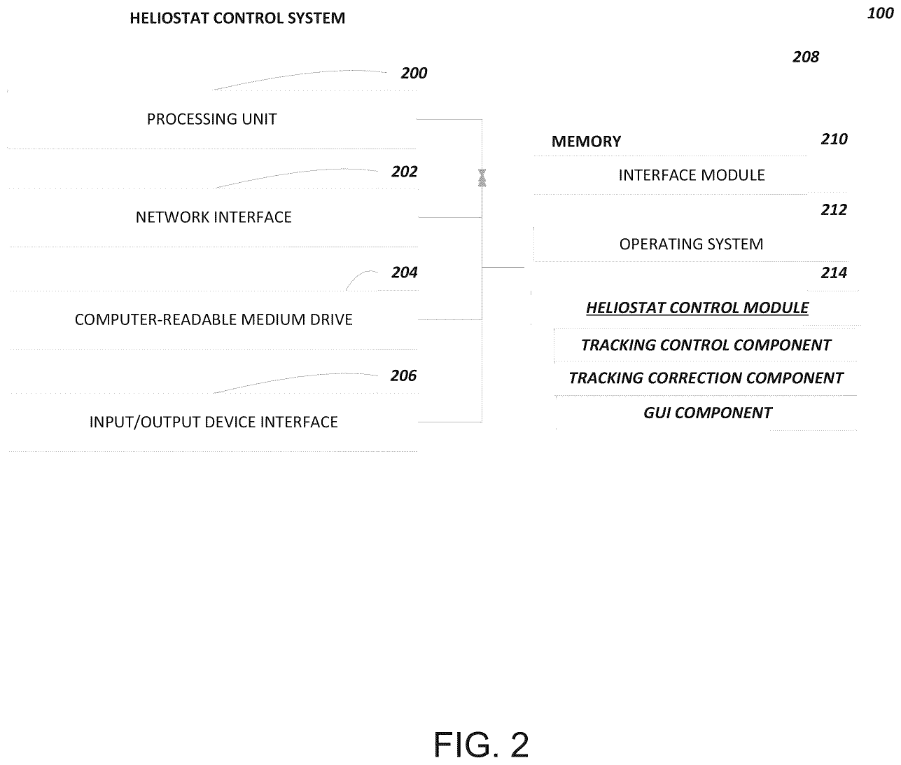

FIG. 2 is a block diagram illustrating example components of the heliostat control system 100. The example heliostat control system 100 includes an arrangement of computer hardware and software components that may be used to implement aspects of the present disclosure. Those skilled in the art will appreciate that the example components may include more (or fewer) components than those depicted in FIG. 2. Optionally, computer hardware and/or software components illustrated in FIG. 2 may be instead or also be included in other systems depicted in FIG. 1A.

The heliostat control system 100 may include one or more processing units 200 (e.g., one or more general purpose processors, FFT processors and/or high-speed graphics processors (GPUs)), one or more network interfaces 202, a non-transitory computer-readable medium drive 204, and an input/output device interface 206, all of which may communicate with one another by way of one or more communication buses. The FFT and/or graphics processors may optionally be utilized to perform the FFTs described herein.

The GPU architecture may comprise multiple processing units, each of which may be configured to execute thousands of threads simultaneously to provide enormous parallel processing power. The processing units may be optimized for handling highly parallel workloads and to perform floating-point calculations efficiently. In order to handle a large amount of data, the GPU memory may include global memory, shared memory, and local memory. Global memory may be the largest (and optionally slowest type of) memory, offering high capacity for storing data. Shared memory may be a fast, low-latency memory that is shared among threads within a process, enabling efficient data sharing and communication. Local memory may be private to each thread and may be used for storing private variables. The GPU may employ a highly parallelized instruction pipeline architecture to execute multiple instructions simultaneously. The pipeline may comprise stages such as instruction fetching, decoding, execution, and memory access. This pipelining enables overlapping of instructions and boosts overall throughput. The GPU may comprise dedicated memory controllers responsible for managing data transfers between the GPU and system memory. The memory controllers may be configured to ensure efficient data access and minimize memory latency via high-bandwidth memory interfaces.

In addition to or instead of a GPU, the heliostat control system 100 may comprise one or more dedicated FFT processors configured to efficiently compute the Fourier transform of a sequence of data points. A given FFT processor may comprise an input data buffer that stores the input sequence of data points. The FFT processor may further comprise a butterfly unit configured to perform the basic computation of the FFT algorithm, which involves combining pairs of input data points and applying complex multiplication and addition operations. The FFT processor may comprise memory units to store intermediate results during the computation. These memory units may be registers or dedicated memory banks to efficiently store and retrieve data during the butterfly operations. An FFT control unit may be provided configured to coordinate the operation of the FFT processor by generating control signals to control the data flow, sequencing, and synchronization of the various components in the processor. Twiddle factors (precomputed complex values), utilized by the FFT algorithm, may be stored in Read-Only Memory (ROM) to provide high speed access to the twiddle factors during the FFT computation. The FFT processor may utilize a pipeline architecture to enhance throughput and efficiency. The pipeline enables multiple data points to be processed simultaneously at different stages of the FFT computation. Such overlapping of computations reduces the overall processing time needed for the transform. The FFT processor may comprise an output data buffer configured to store the transformed data points after the FFT computation (e.g., the resulting frequency domain representation of the input sequence).

The network interface 202 may provide services described herein with connectivity to one or more networks or computing systems (e.g., weather/wind reporting systems, mirror actuators, cameras, temperature sensors, and/or the like). The processing unit 200 may thus receive data (e.g., weather data, images, sensor data, etc.), and/or instructions from other computing devices, systems, or services via a network, and may provide responsive data and/or execute instructions. The processing unit 200 may also communicate to and from memory 204 and further provide output information via the input/output device interface 206. The input/output device interface 206 may also accept input from one or more input devices, such as a keyboard, mouse, digital pen, touch screen, microphone, camera, etc.

The memory 208 may contain computer program instructions that the processing unit 200 may execute in order to implement one or more aspects of the present disclosure. The memory 208 generally includes RAM, ROM (and variants thereof, such as EEPROM) and/or other persistent or non-transitory tangible computer-readable storage media. An interface module 210 may provide access to data in the memory 208 and may enable data to be stored in the memory 208. The memory 208 may store an operating system 212 that provides computer program instructions for use by the processing unit 200 in the general administration and operation of the heliostat control module 214, including its components.

The memory 208 may store images, sensor data, heliostat array configuration data and/or other data described herein.

Some or all of the data and content discussed herein may optionally be stored in a relational database, an SQL database, a NOSQL database, or other database type. Optionally, the memory 208 may include one or more external third-party cloud-based storage systems.

The heliostat control module 214 may include a GUI component that generates graphical user interfaces (e.g., illustrating the actual and processed images of total flux and individual flux from a given mirror) and processes user inputs.

Optionally, the heliostat control module 214 may comprise a tracking control module and a tracking correction module. The tracking control module may be configured to access sun position data, weather data, sensor data, heliostat configuration data (e.g., the number of array mirrors, the mirror sizes, the mirror mounting position, the distance of mirrors from the receiver, other array/mirror data described herein, and/or other configuration data), and desired flux pattern data. The tracking control module may utilize the sun position data, the heliostat configuration data desired flux pattern data to command the respective azimuth and elevation actuators of respective mirrors to cause the mirrors to track the sun so as to reflect light onto the receiver target with the desired flux pattern.

The tracking correction module may be configured to command perturbation devices (e.g., an ultrasonic transducer, a piezoelectric actuator, and electromagnetic shaker, an eccentric rotating mass (ERM) actuator, a voice coil actuator, a hydraulic or pneumatic actuator, or the azimuth and/or elevation actuators themselves) on respective mirrors (e.g., on the back or other side of the mirrors or on the actuators) to vibrate the mirrors at respective different frequencies. For example, a perturbation device of a first mirror may be commanded to vibrate at a first frequency, a perturbation device of a second mirror may be commanded to vibrate at a second frequency (e.g., a first multiple of the first frequency), a perturbation device of a third mirror may be commanded to vibrate at a third frequency (e.g., a second multiple of the first frequency), and so on.

The tracking correction module may be configured to cause a high-resolution camera (e.g., a 14, 16, 18, or 20 bit depth camera) to capture images of the total flux on the receiver target corresponding to the light beams from array mirrors. The tracking correction module may be configured to cause an infrared camera to capture infrared images of the receiver target and/or other portions of the receiver (e.g., so as to detect hot spots and/or cold spots). The tracking correction module may utilize heliostat control system 100 GPUs and/or FFT processors to convert the images from the time domain to the frequency domain. The tracking correction module may utilize the frequency domain images/data to identify a given individual mirror vibrating at a corresponding frequency and to generate a corresponding processed image depicting the flux contribution in the frequency domain.

For example, with respect to the flux from a given mirror, a determination may be made as to where on the receiver target the given mirror's light beam is striking, and the angle/rotation of the beam from normal (e.g., from the y axis). The tracking correction module may compare the total flux to a desired flux and/or the flux from an individual mirror to a desired flux (e.g., a desired position and/or orientation on the receiver target) and determine a corrective position. The tracking correction module (directly or by commanding the tracking control module) may issue commands to the mirror's azimuth and/or elevational actuators to rotate the mirror so as to generate a desired flux. For example, the azimuth and/or elevational actuators may be commanded to rotate the mirror so as to reduce hot spots (e.g., as determined from an infrared camera), reduce cold spots e.g., as determined from an infrared camera), and/or to fill in underfilled areas of the receiver target.

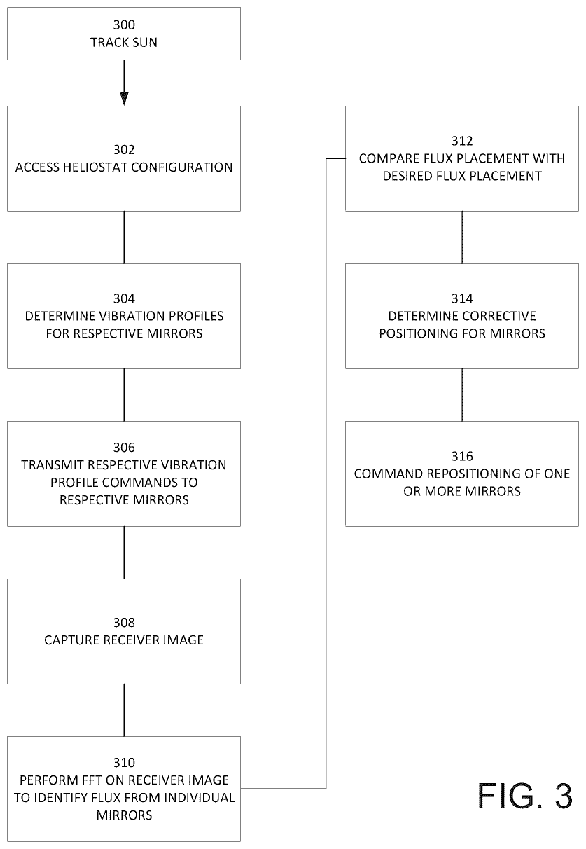

FIG. 3 illustrates an example process. The process may optionally be executed using systems, mirrors, actuators, perturbation devices, and other components described herein. The process blocks may be performed for multiple array mirrors in parallel or sequentially.

At block 300, a heliostat array of mirrors is controlled to track the sun so as to focus light on a heliostat receiver (e.g., a calibrated target on the receiver). The process may continue executing so as to enhance the total flux (e.g., the total flux pattern) by controlling individual mirrors in parallel or sequential so as to achieve a desired painting of the heliostat receiver (e.g., the receiver target) as the sun moves in the sky.

At block 302, the heliostat configuration is accessed from memory and/or otherwise determined. In addition, the current sun position and weather conditions (e.g., solar irradiance, cloud cover, wind speed and direction, etc.) may be accessed. The heliostat configuration may include the number of array mirrors, the mirror sizes, the mirror mounting positions (e.g., latitude, longitude, and altitude or relative to the central receiver tower), the distance of mirrors from the receiver and/or receiver target, the mirror tilt angle (the vertical inclination of the mirror surface) and azimuth angle (the horizontal orientation), heliostat reflectivity, heliostat surface accuracy, tracking control parameters, and/or other such array data.

At block 304, vibration frequencies are determined for the array mirrors. For example, the vibration frequency of each mirror may be a different harmonic of a fundamental frequency or may be a multiple of a step size (e.g., 100 hz, 200 hz, 400 hz, 1 khz, or other step size) different in frequency.

Optionally and advantageously, the respective vibration frequencies of the mirrors may be set so as to have few common prime factors or so the mirror vibration frequencies are set to respective different prime numbers. In the context of the Fast Fourier Transform (FFT) and signal processing, having frequencies with few common prime factors or all prime numbers can lead to a reduction in the number of harmonics in the frequency domain representation. This property is particularly useful in reducing aliasing and other artifacts, may enhance accuracy, and may simplify analysis.

For example if the frequencies of the signals (e.g., from the images of the light on the target) being analyzed have few common prime factors, it means that the frequencies are relatively prime to each other. In this scenario, the harmonics of one frequency are less likely to coincide with the harmonics of another frequency. As a result, when FFTs are performed on the signal, each frequency component will have its distinct peaks in the frequency domain, making it easier to distinguish them from one another.

By way of illustration, consider two example frequencies, f1=100 Hz and f2=130 Hz. These frequencies have no common prime factors, as 100 and 130 are both multiples of different prime numbers (2, 5, and 13). When an FFT is taken of a signal containing these frequencies, there will be distinct peaks at 100 Hz and 130 Hz in the frequency domain.

When all the frequencies are prime numbers, it ensures that there are no common factors between any pair of frequencies. Thus, the harmonics of one frequency cannot coincide with any other frequency. As a result, the frequency domain representation will be even more distinct and easier to interpret.

At block 306, corresponding vibration commands are transmitted (e.g., via a wired or wireless network) to respective perturbation devices on respective mirrors to vibrate the mirrors at the respective different frequencies (e.g., respective different harmonics).

At block 308, one or more images of the total flux on the receiver (e.g., the receiver target) are captured using a high resolution camera. For example, a black and white camera with 14 or 16 bit depth or other adequate depth may be utilized, where the camera bit depth is large enough so that the same number or more shades of grey may be captured and imaged than there are mirrors in the heliostat array, enabling each mirror to be associated with a different shade of grey. The sampling rate may be at least twice the maximum frequency component, in accordance with the Nyquist-Shannon sampling theorem.

At block 310, FFTs may be performed with respect to the image data from one or more images to generate frequency domain representations of the vibrating mirrors. Optionally, to reduce spectral leakage and artifacts in the frequency analysis (e.g., by tapering signal edges), a windowing function may be applied to the sampled data. An FFT algorithm may be applied to the windowed signal to transform it from the time domain to the frequency domain. The result is a complex spectrum representing the amplitude and phase information at different frequencies. The resulting complex spectrum may be further analyzed to extract frequency information. For example, the magnitude spectrum (e.g., absolute values of the complex numbers) may be considered, representing the strength or amplitude of each frequency component. Optionally, peak detection may be performed to identify the peaks or significant frequency components in the magnitude spectrum. These peaks correspond to the frequencies present in the reflected light. Relevant peaks may be identified using various techniques such as thresholding, peak detection algorithms, and/or statistical analysis.

Once the significant peaks are detected, the frequencies associated with the peaks may be estimated. The frequency bins of the FFT output correspond to specific frequencies (e.g., based on the sampling rate and the number of samples used in the FFT). The frequencies of the reflected light may be determined by mapping the peak locations to their corresponding frequencies.

At block 312, the flux contribution (e.g., the flux pattern, position and/or orientation) of a given mirror may be determined using the results of the FFT algorithm, and the contribution may be compared against a desired flux contribution (e.g., flux pattern, position and/or orientation).

At block 314, corrective positioning data (e.g., azimuth and/or elevational data and corresponding positioning commands) are determined given heliostat array mirrors so as to achieve the desired flux contribution for a given array mirror and/or the total flux.

At 316, the corrective positioning commands are transmitted (e.g., over a wired or wireless network) to respective azimuth and/or elevational actuators of respective array mirrors.

The above process may be continuously repeated (e.g., at set time intervals, frequency, and/or in response to environmental conditions, such as detecting winds having a speed above a specified threshold).

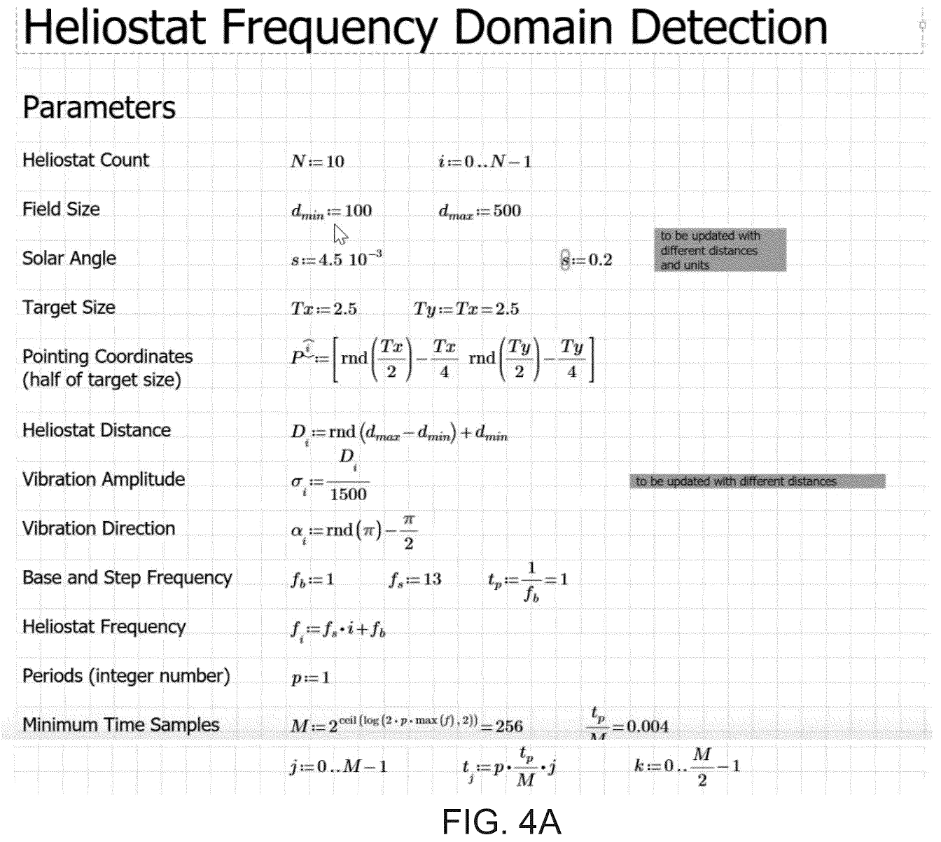

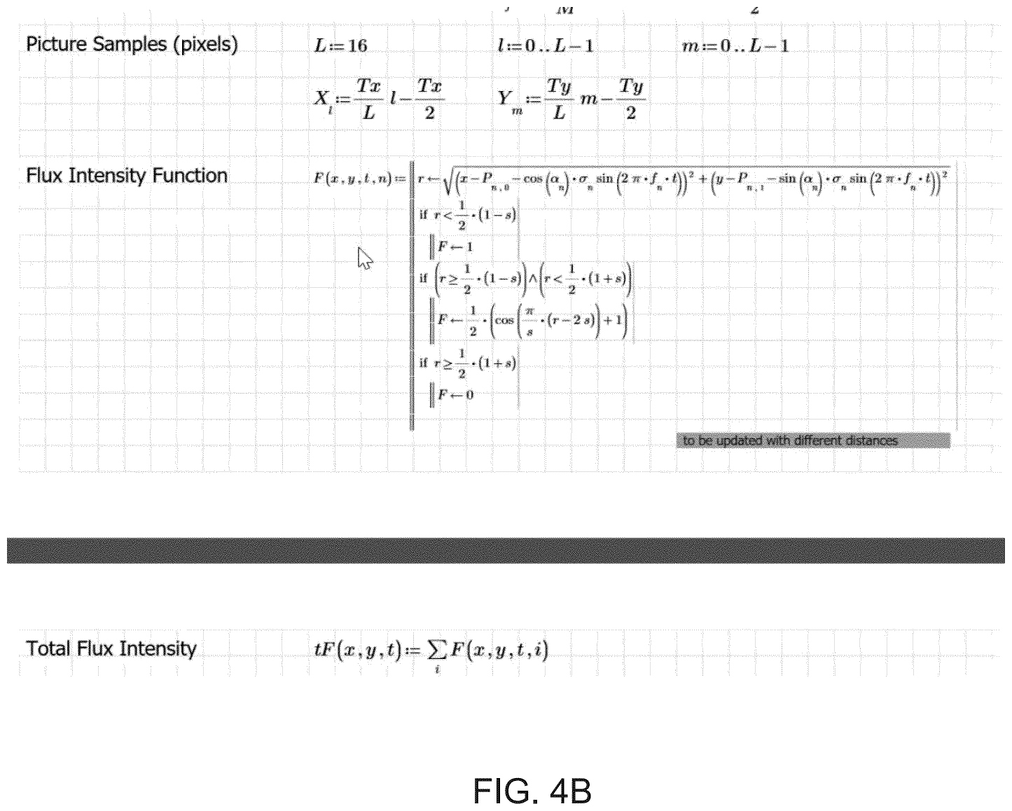

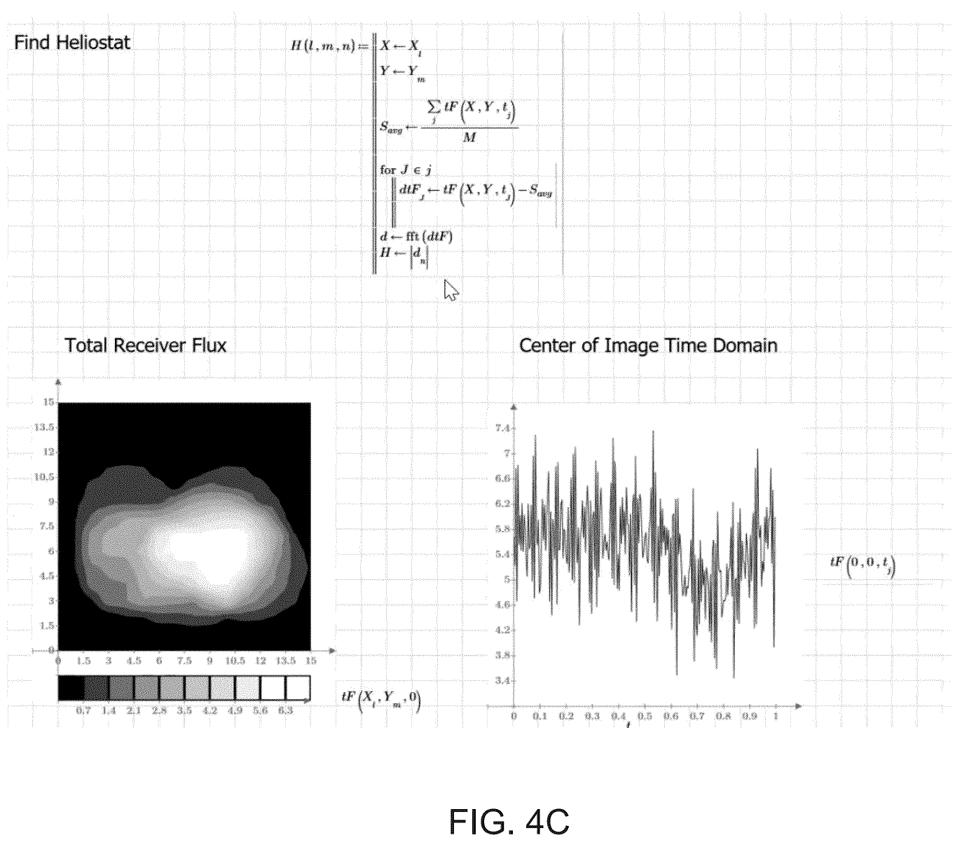

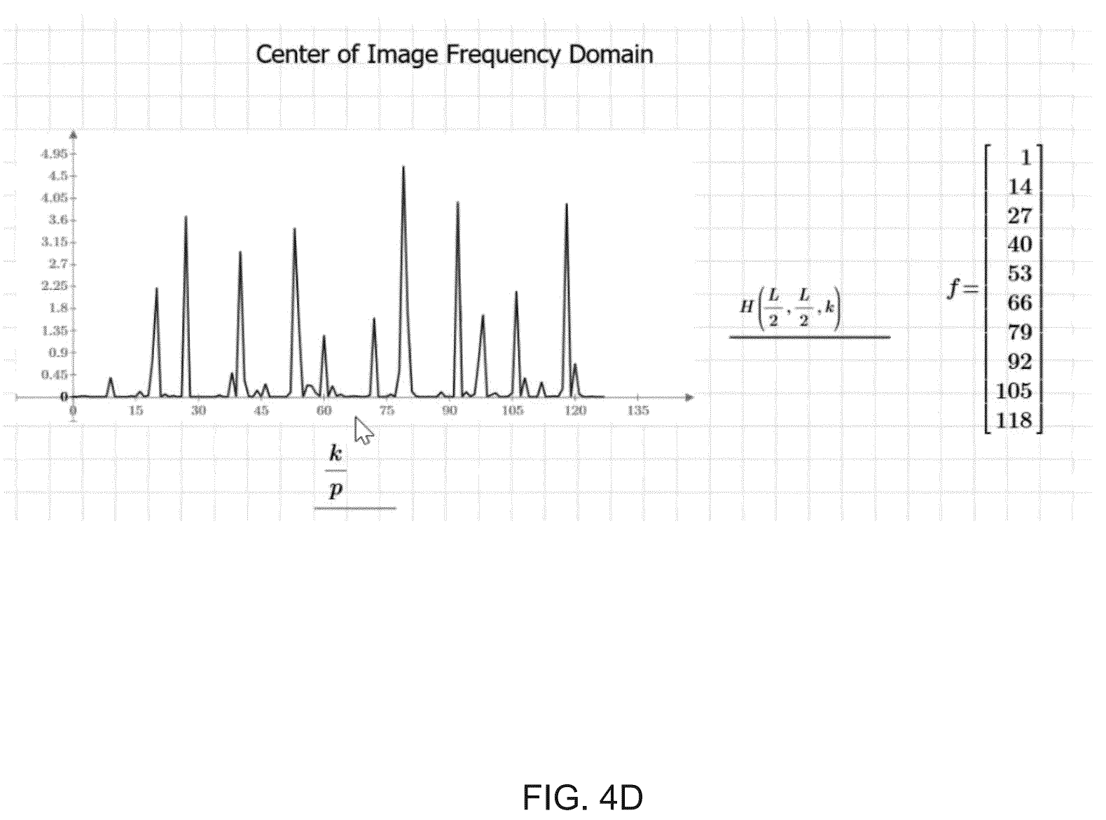

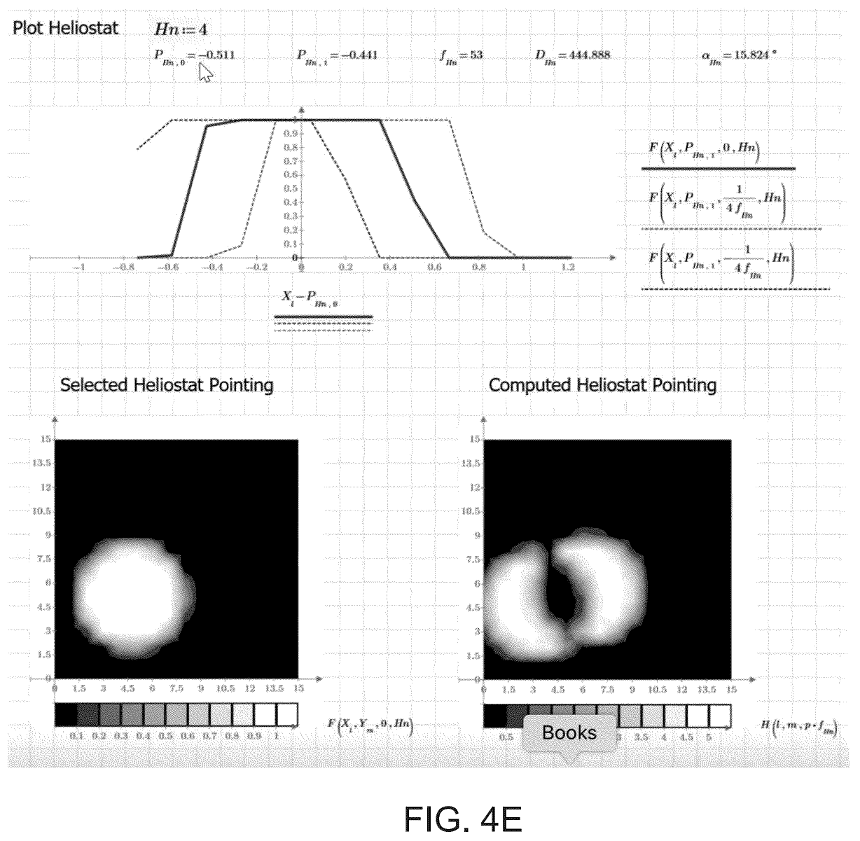

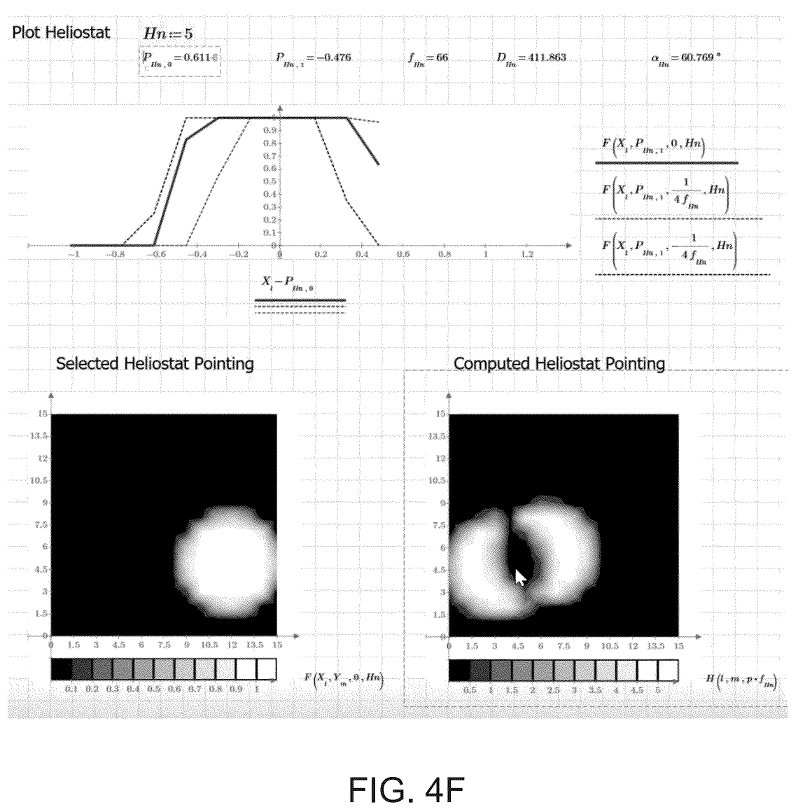

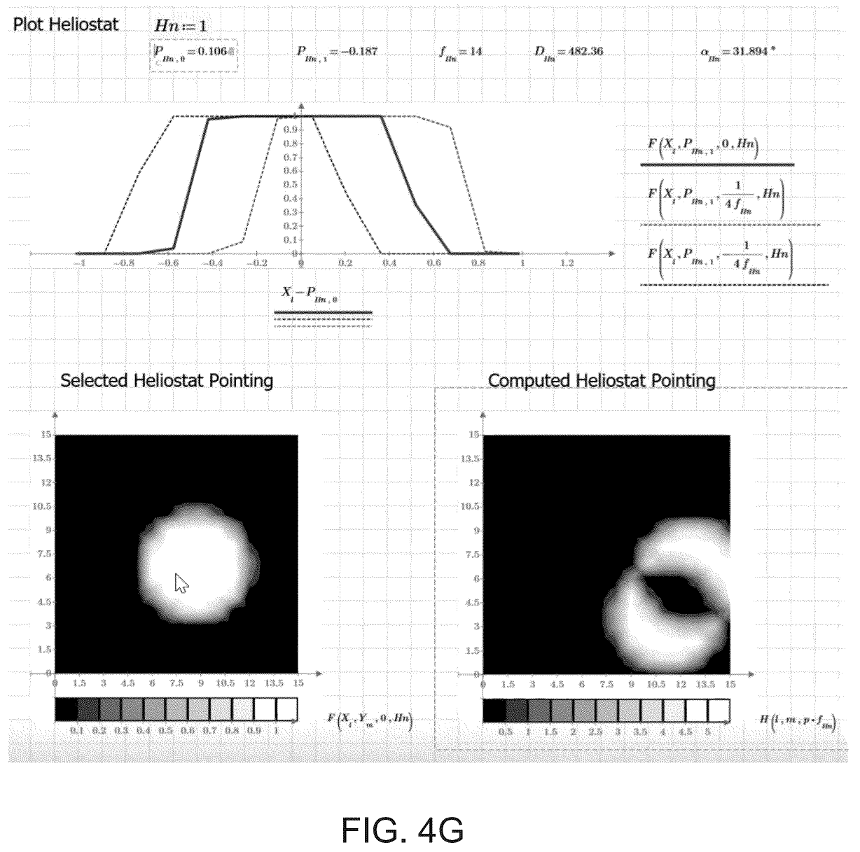

FIGS. 4A-4G illustrate aspects of using an FFT process to determine the flux from respective mirrors.

The heliostat count (the total number of heliostat array mirrors) is determined. In addition, the field size (the depth of the field measured from the receiver tower), solar angle, and target size are determined. The heliostat distance (the distance of a given array mirror from the receiver), the vibration amplitude, and the vibration direction are determined. The base and step mirror vibration frequency and heliostat frequency are determined. The base is the starting frequency, where a given heliostat mirror is provided a vibration frequency=base+n*step that is different from a vibration frequency of other array mirrors.

The minimum time samples (the number of images needed to resolve the lowest mirror vibration frequency, which may be in the form of a movie comprising a plurality of frames) is also determined. In addition, the picture samples (the horizontal and vertical resolutions) are determined.

A picture sample formula is utilized to create an array of pixel coordinates indexed by I, m centered in the target.

A total flux intensity is predicted using a flux intensity function, where X, Y, are target coordinates, t is time, and n is the heliostat mirror number. The flux intensity function provides the intensity at that target point X, Y produced by the lights reflected by heliostat mirror n at a given time. Time is needed as the heliostat mirror moves slightly with a given frequency.

A total receiver flux image is analyzed to generate a center of image time domain graph. The time domain data is processed using an FFT algorithm to generate a frequency domain graph.

A find heliostat formula takes (for a given pixel image indexed the FFT (before it subtracts the average so as to obtain just the oscillation) and returns the FFT value at the frequency of the heliostat n.

Thus, systems and methods are disclosed configured to provide enhanced positioning of heliostat mirrors so as to achieve a desired flux pattern on a central receiver to thereby provide enhanced heliostat performance.

An aspect of the present disclosure relates to a computer system associated with a user, the computer system comprising: at least one processing device operable to: cause a plurality of mirrors in a heliostat array to vibrate at respective different frequencies; capture one or more images of total flux on a heliostat receiver target; cause Fast Fourier Transforms to be performed in real time with respect to the one or more images of the total flux on a heliostat receiver target to obtain frequency domain information; determine in real time a flux contribution by a given individual mirror using the frequency domain information; determine a desired total flux; and individually cause one or more of the plurality of mirrors in the heliostat array to be oriented to obtain the desired total flux.

Optionally, a given mirror is caused to vibrate at a respective frequency using an ultrasonic transducer, a piezoelectric actuator, and electromagnetic shaker, an eccentric rotating mass (ERM) actuator, a voice coil actuator, and/or a hydraulic or pneumatic actuator. Optionally, a given mirror is caused to vibrate at a respective frequency by commanding an azimuth actuator and/or elevation actuator of the given mirror to move back and forth. Optionally, the determination, in real time, of the flux contribution by the given individual mirror is based at least in part on heliostat configuration information including information indicating a distance of the given mirror to the receiver. Optionally, the images of total flux on the heliostat receiver target are captured using a camera having a 14 or 16 bit depth. Optionally, the system is further configured to: capture infrared images of the receiver target using an infrared camera; identify hot spots and/or cold spots on the receiver target using the infrared images; based at least in part on the identified hot spots and/or cold spots, orient one or more of the plurality of mirrors in the heliostat array so as to reduce the hot spots and/or cold spots. Optionally, the computer system comprises a graphics processor and/or a Fast Fourier Transform processor. Optionally, a separate target screen and sensors at a perimeter of the receiver are not utilized in determining a flux contribution by a given individual mirror.

An aspect of the present disclosure relates to a computer-implemented method, the method comprising: causing a plurality of mirrors in a heliostat array to vibrate at respective different frequencies; causing one or more images to be captured of total flux on a heliostat receiver target; causing Fast Fourier Transforms to be performed in real time with respect to the one or more images of the total flux on a heliostat receiver target to obtain frequency domain information; determining in real time a flux contribution by a given individual mirror using the frequency domain information; determining a desired total flux; and causing one or more of the plurality of mirrors in the heliostat array to be oriented to obtain the desired total flux.

Optionally, a given mirror is caused to vibrate at a respective frequency using an ultrasonic transducer, a piezoelectric actuator, and electromagnetic shaker, an eccentric rotating mass (ERM) actuator, a voice coil actuator, and/or a hydraulic or pneumatic actuator. Optionally, a given mirror is caused to vibrate at a respective frequency by commanding an azimuth actuator and/or elevation actuator of the given mirror to move back and forth. Optionally, the determination, in real time, of the flux contribution by the given individual mirror is based at least in part on heliostat configuration information including information indicating a distance of the given mirror to the receiver. Optionally, the images of total flux on the heliostat receiver target are captured using a camera having a bit depth sufficient to at least generate an image with more shades of grey than there are mirrors in the plurality of mirrors in the heliostat array. Optionally, the method further comprises: capturing infrared images of the receiver target using an infrared camera; identifying hot spots and/or cold spots on the receiver target using the infrared images; based at least in part on the identified hot spots and/or cold spots, orienting one or more of the plurality of mirrors in the heliostat array so as to reduce the hot spots and/or cold spots. Optionally, the method further comprising using a graphics processor to perform Fast Fourier Transforms. Optionally, the method further comprises using a Fast Fourier Transform processor to perform Fast Fourier Transforms. Optionally, a separate target screen and sensors at a perimeter of the receiver are not utilized in determining a flux contribution by a given individual mirror.

An aspect of the present disclosure relates to methods and systems for enhancing the flux distribution on a heliostat receiver target. A plurality of mirrors in a heliostat array are caused to vibrate at respective different frequencies. One or more images are captured of the total flux on a heliostat receiver target. Fast Fourier Transforms are performed in real time with respect to the one or more images of the total flux on the heliostat receiver target to obtain frequency domain information. A real time determination is made of the flux contribution by a given individual mirror using the frequency domain information. A desired total flux distribution is determined. One or more of the plurality of mirrors in the heliostat array are caused to be oriented to obtain the desired total flux.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources, or may comprise a standalone system. Two or more components of a system can be combined into fewer components. Various components of the illustrated systems can be implemented in one or more virtual machines, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data processing apparatus to produce a machine, such that the instructions, which execute via the processor(s) of the computer or other programmable data processing apparatus, create means for implementing the acts specified in the flow chart and/or block diagram block or blocks. These computer program instructions may also be stored in a non-transitory computer-readable memory that can direct a computer or other programmable data processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

While the phrase “click” may be used with respect to a user selecting a control, menu selection, or the like, other user inputs may be used, such as voice commands, text entry, gestures, etc. User inputs may, by way of example, be provided via an interface, such as via text fields, wherein a user enters text, and/or via a menu selection (e.g., a drop down menu, a list or other arrangement via which the user can check via a check box or otherwise make a selection or selections, a group of individually selectable icons, etc.). When the user provides an input or activates a control, a corresponding computing system may perform the corresponding operation. Some or all of the data, inputs and instructions provided by a user may optionally be stored in a system data store (e.g., a database), from which the system may access and retrieve such data, inputs, and instructions. The notifications and user interfaces described herein may be provided via a Web page, a dedicated or non-dedicated phone or mobile application, computer application, a short messaging service message (e.g., SMS, MMS, etc.), instant messaging, email, push notification, audibly, via haptic feedback, and/or otherwise.

The user terminals described herein may be in the form of a mobile communication device (e.g., a cell phone), laptop, tablet computer, interactive television, game console, media streaming device, head-wearable display, networked watch, etc. The user terminals may optionally include displays, user input devices (e.g., touchscreen, keyboard, mouse, microphone, camera, touch pad, etc.), network interfaces, etc.

Any patents and applications and other references noted above, including any that may be listed in accompanying filing papers, are incorporated herein by reference. Aspects of the invention can be modified, if necessary, to employ the systems, functions, and concepts of the various references described above to provide yet further implementations of the invention. These and other changes can be made to the invention in light of the above Detailed Description. While the above description describes certain examples of the invention, and describes the best mode contemplated, no matter how detailed the above appears in text, the invention can be practiced in many ways. Details of the system may vary considerably in its specific implementation, while still being encompassed by the invention disclosed herein. As noted above, particular terminology used when describing certain features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed in the specification, unless the above Detailed Description section explicitly defines such terms. Accordingly, the actual scope of the invention encompasses not only the disclosed examples, but also all equivalent ways of practicing or implementing the invention under the claims.

To reduce the number of claims, certain aspects of the invention are presented below in certain claim forms, but the applicant contemplates other aspects of the invention in any number of claim forms. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. A computer system associated with a user, the computer system comprising:
at least one processing device operable to:
cause a plurality of mirrors in a heliostat array to vibrate at respective different frequencies;
capture one or more images of total flux on a heliostat receiver target;
cause Fast Fourier Transforms to be performed in real time with respect to the one or more images of the total flux on a heliostat receiver target to obtain frequency domain information;
determine in real time a flux contribution by a given individual mirror using the frequency domain information;
determine a desired total flux; and
individually cause one or more of the plurality of mirrors in the heliostat array to be oriented to obtain the desired total flux.

2. The computer system as defined in claim 1, wherein a given mirror is caused to vibrate at a respective frequency using an ultrasonic transducer, a piezoelectric actuator, and electromagnetic shaker, an eccentric rotating mass (ERM) actuator, a voice coil actuator, and/or a hydraulic or pneumatic actuator.

3. The computer system as defined in claim 1, wherein a given mirror is caused to vibrate at a respective frequency by commanding an azimuth actuator and/or elevation actuator of the given mirror to move back and forth.

4. The computer system as defined in claim 1, wherein the determination, in real time, of the flux contribution by the given individual mirror is based at least in part on heliostat configuration information including information indicating a distance of the given mirror to the receiver.

5. The computer system as defined in claim 1, wherein the images of total flux on the heliostat receiver target are captured using a camera having a 14 or 16 bit depth.

6. The computer system as defined in claim 1, wherein the system is further configured to:
capture infrared images of the receiver target using an infrared camera;
identify hot spots and/or cold spots on the receiver target using the infrared images;
based at least in part on the identified hot spots and/or cold spots, orient one or more of the plurality of mirrors in the heliostat array so as to reduce the hot spots and/or cold spots.

7. The computer system as defined in claim 1, further comprising a graphics processor.

8. The computer system as defined in claim 1, further comprising a Fast Fourier Transform processor.

9. The computer system as defined in claim 1, wherein a separate target screen and sensors at a perimeter of the receiver are not utilized in determining a flux contribution by a given individual mirror.

10. A computer-implemented method, the method comprising:
causing a plurality of mirrors in a heliostat array to vibrate at respective different frequencies;
causing one or more images to be captured of total flux on a heliostat receiver target;
causing Fast Fourier Transforms to be performed in real time with respect to the one or more images of the total flux on a heliostat receiver target to obtain frequency domain information;
determining in real time a flux contribution by a given individual mirror using the frequency domain information;
determining a desired total flux; and
causing one or more of the plurality of mirrors in the heliostat array to be oriented to obtain the desired total flux.

11. The computer-implemented method system as defined in claim 10, wherein a given mirror is caused to vibrate at a respective frequency using an ultrasonic transducer, a piezoelectric actuator, and electromagnetic shaker, an eccentric rotating mass (ERM) actuator, a voice coil actuator, and/or a hydraulic or pneumatic actuator.

12. The computer-implemented method system as defined in claim 10, wherein a given mirror is caused to vibrate at a respective frequency by commanding an azimuth actuator and/or elevation actuator of the given mirror to move back and forth.

13. The computer-implemented method system as defined in claim 10, wherein the determination, in real time, of the flux contribution by the given individual mirror is based at least in part on heliostat configuration information including information indicating a distance of the given mirror to the receiver.

14. The computer-implemented method system as defined in claim 10, wherein the images of total flux on the heliostat receiver target are captured using a camera having a bit depth sufficient to at least generate an image with more shades of grey than there are mirrors in the plurality of mirrors in the heliostat array.

15. The computer-implemented method system as defined in claim 10, the method further comprising:
capturing infrared images of the receiver target using an infrared camera;
identifying hot spots and/or cold spots on the receiver target using the infrared images;
based at least in part on the identified hot spots and/or cold spots, orienting one or more of the plurality of mirrors in the heliostat array so as to reduce the hot spots and/or cold spots.

16. The computer-implemented method system as defined in claim 10, the method further comprising using a graphics processor to perform Fast Fourier Transforms.

17. The computer-implemented method system as defined in claim 10, the method further comprising using a Fast Fourier Transform processor to perform Fast Fourier Transforms.

18. The computer-implemented method system as defined in claim 10, wherein a separate target screen and sensors at a perimeter of the receiver are not utilized in determining a flux contribution by a given individual mirror.
